(19) United States
(12) Patent Application Publication
(10) Pub. No.: US 2017/0313466 A1
(43) Pub. Date: Nov. 2, 2017

(54) Fold-Flat Carrying Box

(71) Applicants: Yaming YEH, Taipei (TW); Yulin CHIANG, Alhambra, CA (US)

(72) Inventors: Yaming YEH, Taipei (TW); Yulin CHIANG, Alhambra, CA (US)

(21) Appl. No.: 15/141,041

(22) Filed: Apr. 28, 2016

(51) Int. Cl. B65D 5/36; A47J 47/14; B65D 5/20; B65D 5/42

(52) U.S. Cl. CPC B65D 5/3635; B65D 5/4266; A47J 47/14; B65D 5/2057

(57) ABSTRACT

The present invention disclosed a fold-flat carrying box that's easy to store and transport. When it comes time to use a carrying box, it can easily be folded up, along with the pre-made fold lines, into a box-shape container and ready for customers' need. The materials for the carrying box can be made from paper of suitable stock, or plastic or other flexible materials, greatly increasing the ease of use and lowering the cost of storage and transportation.

### FIELD AND BACKGROUND OF THE INVENTION

The present invention relates to a carrying box, especially a food carrying box that's easy to store and transport, due to the collapsed state of being flat.

Particularly in the fast-food and restaurant business, takeout box is an important item for the businesses. Such takeout carrying boxes are typically stacked together and are retrieved from the stack, one by one, when the restaurant operators are about to put food into the boxes.

Such stacks of boxes take up lots of space, for storage and transportation. Restaurant operators no doubt would welcome some improved box design that can provide ease of use and lower cost of storage and transportation.

A competitive design, as shown in U.S. Pat. No. 6,443,308 (308 Patent), entitled “Beverage and food carrier”, provided a foldable box design, similarly having fold-flat collapsed configuration. However, the 308 Patent is a two-piece construction and the task of erecting the material to form a box is a lot more complicated and not really user-friendly.

The fold-flat carrying box of present application stays flat, for ease of storage and transportation. When it comes time to use a carrying box, it can easily be folded up, along with the pre-made fold lines, into a box-shape container and ready for use by the restaurant operators to fit customers' needs.

### SUMMARY OF THE INVENTION

Present invention disclosed an elegant design for a carrying box, especially a food carrying box, with fold flat configuration that can be easily turned to the box configuration that is ready for use.

The fold-flat carrying box of present application is made up of two identical top planar pieces 100, each top planar piece 100 has multiple fold lines that define section pieces separated by straight fold lines.

The dotted lines on FIG. 6 show all the fold lines.

The fold-flat box further has a bottom planar piece 200. The bottom planar piece 200 contains 5 connected section pieces divided by 4 parallel fold lines.

A portion of the each of the two identical top planar pieces 100 is fixedly attached to the middle 3 connected section pieces.

The two end section pieces form a cover surface on the top of a box in a folded up box configuration.

Additionally, an end section piece has a protruding hook tab, which is sized to insert through a receiving slit on the end section piece, so that the hook tab can be inserted into and through the slit and form a temporary connection to cover the opening of the carrying box in the fold up box configuration, as shown in the figures.

Two identical top planar pieces 100 and the bottom planar piece 200 can be made from the same single planar material.

### DESCRIPTION OF THE DRAWINGS

The accompanying drawings, which are incorporated in and constitute a part of this specification, illustrate the preferred embodiments of the invention and together with the description, serve to explain the principles of the invention.

Such drawings are exemplary implementations of the invention as disclosed and are not limiting the scope of the claims as supported by the disclosure made herein.

A brief description of the drawings is as follows:

FIG. 1 shows the top planar piece containing the section pieces.

FIG. 2 shows the bottom planar piece containing the section pieces.

FIG. 3 shows one top planar piece folded flat to the bottom planar piece.

FIG. 4 shows the other top planar piece folded flat to the bottom planar piece.

FIG. 5 shows both top planar pieces folded flat, with some overlapping portion.

FIG. 6 shows the top planar pieces and the bottom planar piece are made from a single piece of uniform material.

FIG. 7 shows the fold-flat carrying box in a half fold down state.

FIG. 8 shows the fold-flat carry box in a fully assert bled, lid closed with a hook tab inserted into the corresponding slit.

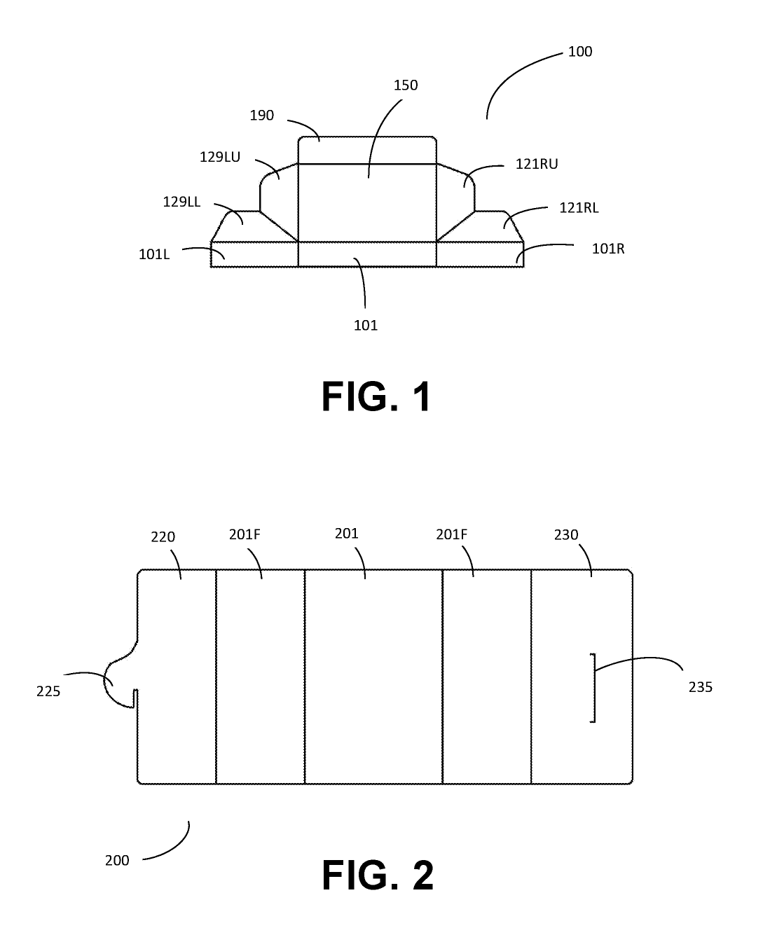

### DETAILED DESCRIPTION OF THE PREFERRED EMBODIMENT

The present invention teaches the construction of a fold-flat carrying box that is easy to transport and for storage, while convenient in folding up to form a ready-for-use box, for any intended purposes, such as carrying food items.

The fold-flat carrying box 300 of present application is comprised of two identical top planar pieces 100, each top planar piece 100 has multiple fold lines that define section pieces 101, 101L, 101R, 150, 129LU, 129LL, 121RU, 121RL, and 190.

The letters L and R are chosen to signify Left and Right, viewed from the perspective as presented in the drawings. The letters LU, LL, RU, RL are chosen to signify Left Upper, Left Lower, Right Upper, and Right Lower, viewed from the perspective as presented in the drawings. These letters do not have any special significance and are chosen to work with the numerals for ease of description.

The fold lines are the straight line segments separating the connected section pieces, allowing two adjacent section pieces to form an angle when the top planar piece 100 is folded along a particular fold line.

For example, the section piece 190 can have an angle relative to section piece 150, along the fold line between these two section pieces.

The section pieces 101L, 101, and 101R can have an angle relative to other section pieces on the top planar piece 100, along the fold lines separating 101L/101/101R and other section pieces.

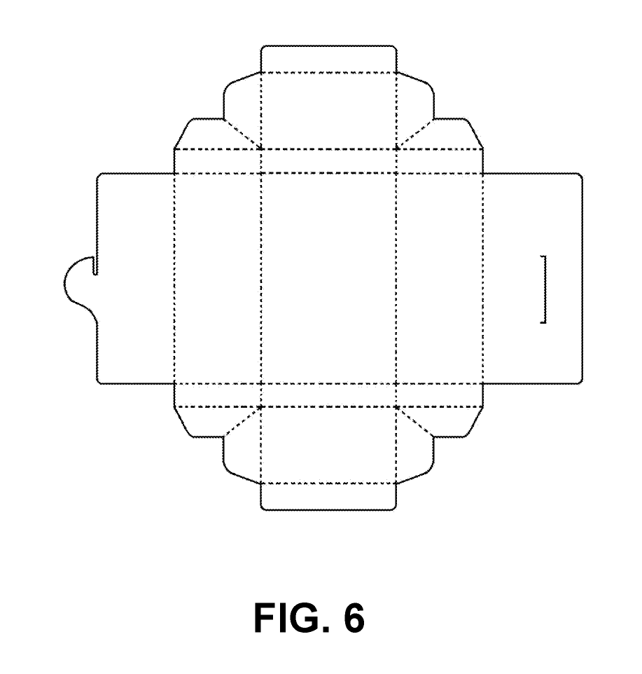

The dotted lines on FIG. 6 show all the fold lines.

The fold-flat box 300 further has a bottom planar piece 200. The bottom planar piece 200 contains 5 connected section pieces divided by 4 parallel fold lines, as shown in FIG.

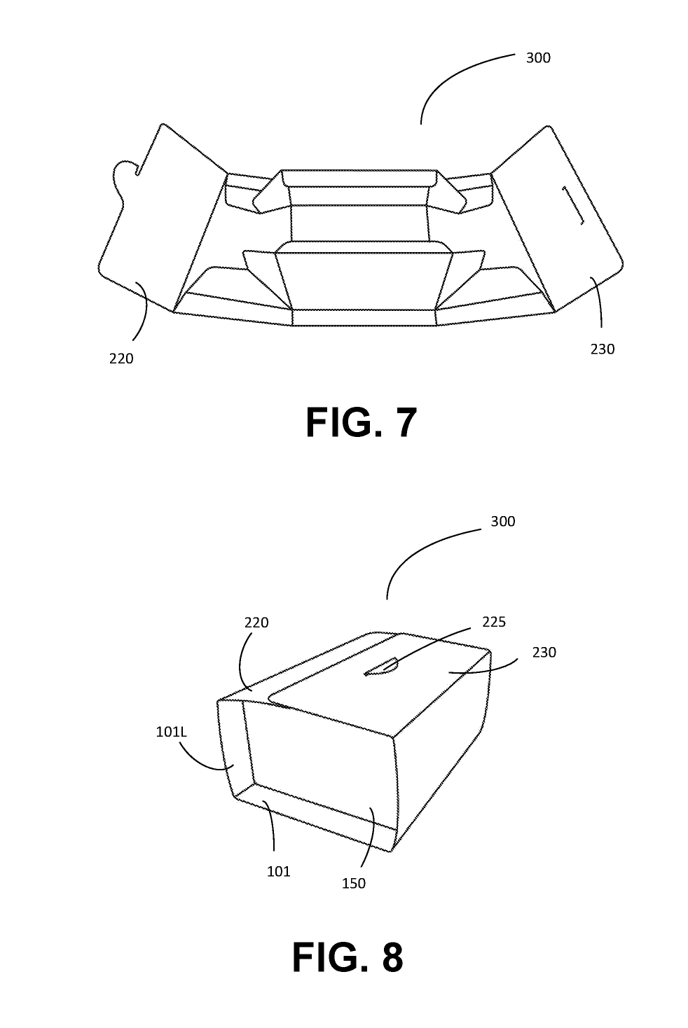

In the half-folded state as shown in FIG. 7, two outer fold lines of the bottom planar piece 200 can be seen and the two inner fold lines are partially covered from view, obscured by a top planar piece 100 closer to the eyes of a viewer, in the angle as presented in the drawing.

The 5 connected section pieces contain a central section piece 201, 2 section pieces 201F flanking the central section piece 201, and 2 end section pieces 220 and 230 that are connected to section pieces 201Fs, as shown in FIG. 2.

A portion of the each of the two identical top planar pieces 100 is fixedly attached to the middle 3 connected section pieces 201F, 201, and 201F on opposite edges of the bottom planar piece 200.

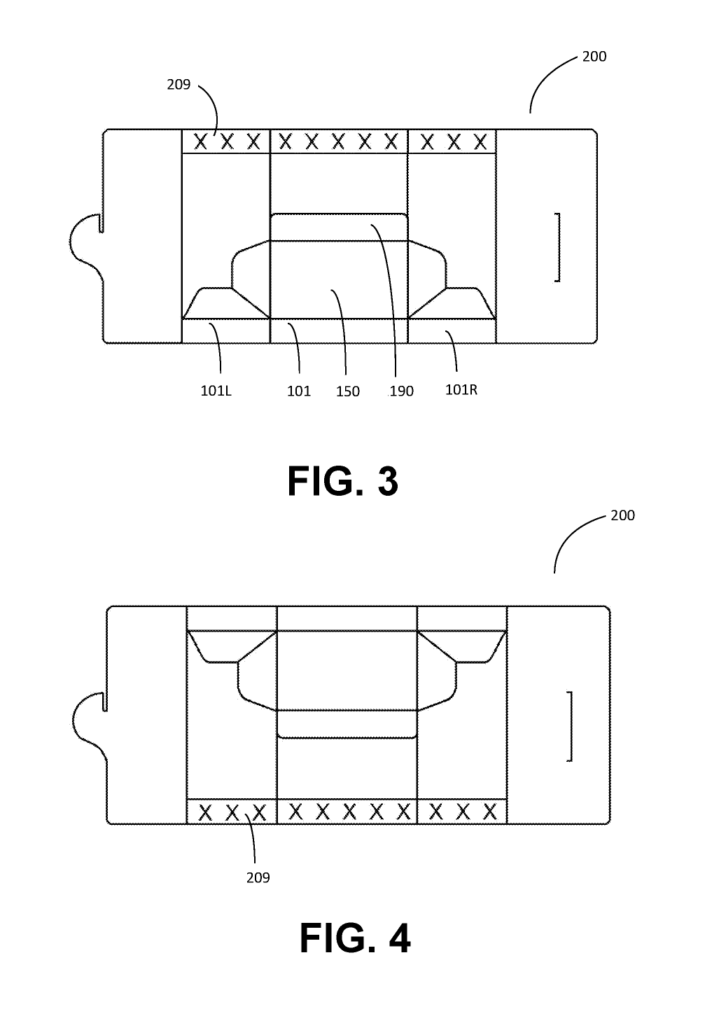

FIG. 3 contains only one top planar 100 fixedly attached to the bottom planar piece 200, leaving the other side blank to show the area where the other top planar piece 100 will be fixedly attached.

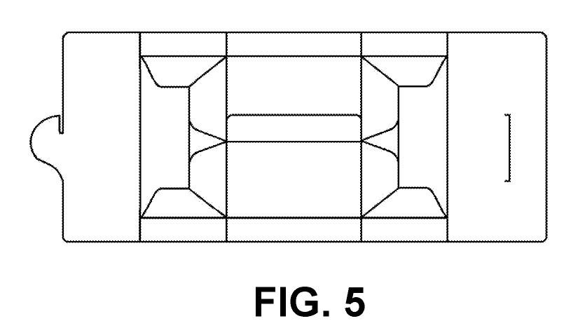

FIG. 4 shows another top planar piece 100 fixedly attached.

A strip area, marked with 209 and shown with “x” markings, represent the area in the middle 3 connection section pieces where the top planar piece 100 is fixedly attached to, allowing the top planar pieces 100 to fold up along the fold line.

Specifically, it is the portion made up of sections 101L, 101, and 101R that will be fixedly attached to the 209 area in the middle 3 section pieces 201F, 201, and 201F.

The section piece 190, of each of the two identical top planar pieces 100, will fold to form a kind of a “sleeve” structure to attachingly receive the two end pieces 220 and 230 when in a folded up box configuration

The two end section pieces 220 and 230 will form a cover surface on the top of a box in a folded up box configuration.

Additionally, the end section piece 220 has a protruding hook tab 225, which is sized to insert through a receiving slit 235 on the end section piece 230, so that the hook tab 225 can be inserted into and through the slit 235 and form a temporary connection to cover the opening of the carrying box in the fold up box configuration, as shown in the figures.

FIG. 8 shows the hook tab 225 inserted into the slit 235 in a fully assembled, closed lid state.

FIG. 5 show the best mode storage and transportation configuration of the fold-flat carrying box of present invention, where the two top planar pieces 100 are folded flat toward each other, and on the same plane as the bottom planar piece 200.

In another embodiment, the two identical top planar pieces 100 and the bottom piece 200 are made from the same single planar material, as shown in FIG. 6.

The dotted lines on FIG. 6 show all the fold lines.

FIGS. 5-8 clearly show the advantages of present invention where the flattened structure can be unfolded and erected into a box shape, ready for use for its intended purpose of carrying food, or other items.

What is claimed is:

1. A fold-flat carrying box, comprising,
two identical top planar pieces each having multiple fold lines that define section pieces; and
a bottom planar piece having 5 connected section pieces divided by 4 parallel fold lines,
wherein a portion of the each of the two identical top planar pieces is fixedly attached to the middle 3 connected section pieces on opposite edges of the bottom planar piece, and the two section pieces on the two ends will form a cover on the top of the carrying box of present application.

2. The fold-flat carrying box of claim 1, further comprising a protruding hook tab on an end section piece and a receiving slit on the other end section piece so that the hook tab can be inserted into the slit and form a temporary connection to cover the opening of the carrying box when the 5 connected section pieces are folded up into a box shape.

3. The fold-flat carrying box of claim 1, wherein the two identical top planar pieces and the bottom planar piece are made from the same planar material.

4. The fold-flat carrying box of claim 1, wherein the top planar pieces and the bottom planar pieces are made from paper material of suitable paper stock for easy folding.

5. The fold-flat carrying box of claim 1, wherein the top planar pieces and the bottom planar piece are made from suitable plastic or other flexible materials.
